(19) United States
(12) Patent Application Publication
(10) Pub. No.: US 2007/0223701 A1
(43) Pub. Date: Sep. 27, 2007

(54) METHOD AND APPARATUS FOR UTILIZING MULTIPLE GROUP KEYS FOR SECURE COMMUNICATIONS

(75) Inventors: Stephen P. Emeott, Rolling Meadows, IL (US); Anthony J. Braskich, Palatine, IL (US)

Correspondence Address: MOTOROLA, INC., 1303 EAST ALGONQUIN ROAD, IL01/3RD, SCHAUMBURG, IL, 60196, US

(73) Assignee: Motorola, Inc.

(21) Appl. No.: 11/275,795

(22) Filed: Jan. 30, 2006

(51) Int. Cl. H04K 1/00

(52) U.S. Cl. 380/270

(57) ABSTRACT

A method and apparatus for utilizing multiple group keys for secure communications among nodes is provided herein. During operation an access point will utilize a plurality of Medium Access Controller (MAC) Addresses, one for each service provided. Each MAC address has an associated lookup table containing encryption keys. From the perspective of nodes using a first service, group traffic sent using the MAC address for the second service is ignored, and no decryption attempt is made. Likewise, group traffic sent using the MAC address for the first service is ignored for group traffic using the second service.

### FIELD OF THE INVENTION

The present invention relates generally to secure communication of nodes within a network and in particular, to a method and apparatus for utilizing multiple group keys for secure communications.

### BACKGROUND OF THE INVENTION

Secure communications between nodes within a communication system often require the encryption of communications between the nodes. Additionally, certain mesh access points in a wireless local area network (WLAN) mesh network can serve as access points (APs) for simple (non-mesh) nodes. These Mesh APs (MAPs) provide two services: the mesh service (forwarding traffic within the mesh network) and the AP service (traffic delivery to and from associated nodes). Ideally, the group traffic for different services (mesh services versus AP services) should be encrypted using different group keys. That is, multicast traffic sent to other mesh points in the WLAN mesh should be encrypted using a group key that the nodes associated with the MAP do not know.

A problem exists in that according to the 802.11 specification, each AP's MAC can only communicate utilizing one group encryption key for all users. Therefore, a need exists for a method and apparatus for utilizing multiple group keys for secure communications among nodes using differing services.

### BRIEF DESCRIPTION OF THE DRAWINGS

FIG. 1 is a block diagram of a network.

FIG. 2 is a block diagram of an access point within the network of FIG. 1.

FIG. 3 illustrates the storage of MAC addresses and encryption keys.

FIG. 4 is a flow chart showing operation of the access point of FIG. 2.

FIG. 5 illustrates a frame structure utilized by the network of FIG. 1.

### DETAILED DESCRIPTION OF THE DRAWINGS

In order to address the above-mentioned need, a method and apparatus for utilizing multiple group keys for secure communications among nodes is provided herein. During operation an access point will utilize a plurality of Medium Access Controller (MAC) Addresses, one for each service provided. Each MAC address has an associated lookup table containing encryption keys. From the perspective of nodes using a first service, group traffic sent using the MAC address for the second service is ignored, and no decryption attempt is made. Likewise, group traffic sent using the MAC address for the first service is ignored for group traffic using the second service.

A specific benefit of the above transmission scheme is that it has the ability to separate nodes using differing services. This permits multiple classes of users, with, for example, simple nodes being a less-trusted group. In such a case, the ability of a malicious simple node user to affect the mesh network operation is limited.

The present invention encompasses a method for transmitting data to a first and a second group of nodes within a network. The method comprises the steps of transmitting data and a first MAC address to the first group of nodes, the data encrypted with a first encryption key. Second data and a second MAC address is then transmitted to the second group of nodes, the second data encrypted with a second encryption key.

The present invention additionally encompasses a method comprising the steps of receiving data from a local area network, determining an identity for nodes that will receive the data, determining a service used by the nodes that will receive the data, and determining a MAC address and encryption key for each service used by the nodes. Data, a first MAC address, and a first encryption key identification are transmitted to a first node utilizing a first service, the data encrypted with a first encryption key that is identified by the first encryption key identification. Finally, second data, a second MAC address, and a second encryption key identification are transmitted to a second node utilizing a second service, the second data encrypted with a second encryption key that is identified by the second encryption key identification.

The present invention additionally encompasses an apparatus comprising a first MAC address, a first encryption key associated with the first MAC address, a second MAC address, a second encryption key associated with the second MAC address, and a transmitter transmitting data, the first MAC address, and a first encryption key identification to a first node utilizing a first service, the data encrypted with the first encryption key, the transmitter additionally transmitting second data, the second MAC address, and a second encryption key identification to a second node utilizing a second service, the second data encrypted with the second encryption key.

Prior to describing a method and apparatus for utilizing multiple group keys for secure communications, the following definitions are provided to set the necessary background for utilization of the present invention.
access point—a hardware device or computer software that acts as a communication hub for users of a wireless device to connect to a distribution system (DS), such as a wired local area network (LAN). One of the security roles of an AP is to provide access to the DS to authorized nodes, and only authorized nodes, via a RF communication channel.
service—a particular feature used by a node. Such features include, but are not limited to, a communication system protocol (e.g., mesh, which supports the control, management, and operation of a mesh or supports the forwarding of frames between nodes within the mesh; and non-mesh, which supports the forwarding of traffic to nodes outside the mesh), a broadcast service (e.g., mesh, which supports the distribution of control or management traffic within a mesh; and non-mesh, which supports the distribution of internet protocol (IP) broadcast protocol data units or video and/or audio multicast traffic to nodes outside the mesh), a means of authorizing and authenticating users with certain access rights, . . . , etc.
mesh network—Also called mesh topology or a mesh distribution system, a mesh network is a network topology in which devices are connected with many redundant interconnections between network nodes, some of which may span multiple mesh links. In a true mesh topology every node has a connection to every other node in the network via one or more mesh links.
Mesh link—a bi-directional RF communication channel between two mesh nodes
Medium Access Controller (MAC) Address—a hardware address that uniquely identifies each node of a network. In IEEE 802 networks, the Data Link Control (DLC) layer of the OSI Reference Model is divided into two sublayers: the Logical Link Control (LLC) layer and the Media Access Control (MAC) layer. The MAC layer interfaces directly with the network medium. Consequently, each different type of network medium requires a different MAC layer. On networks that do not conform to the IEEE 802 standards but do conform to the OSI Reference Model, the node address is called the Data Link Control (DLC) address.
Multicast MAC address—A MAC address for a group of nodes. In IEEE 802 networks, the group bit is bit 0 of the first octet of the MAC address and is set to 1. The Broadcast address is a unique multicast address that specifies all nodes, and which in IEEE 802 networks equals a multicast MAC address with all bits set to 1.

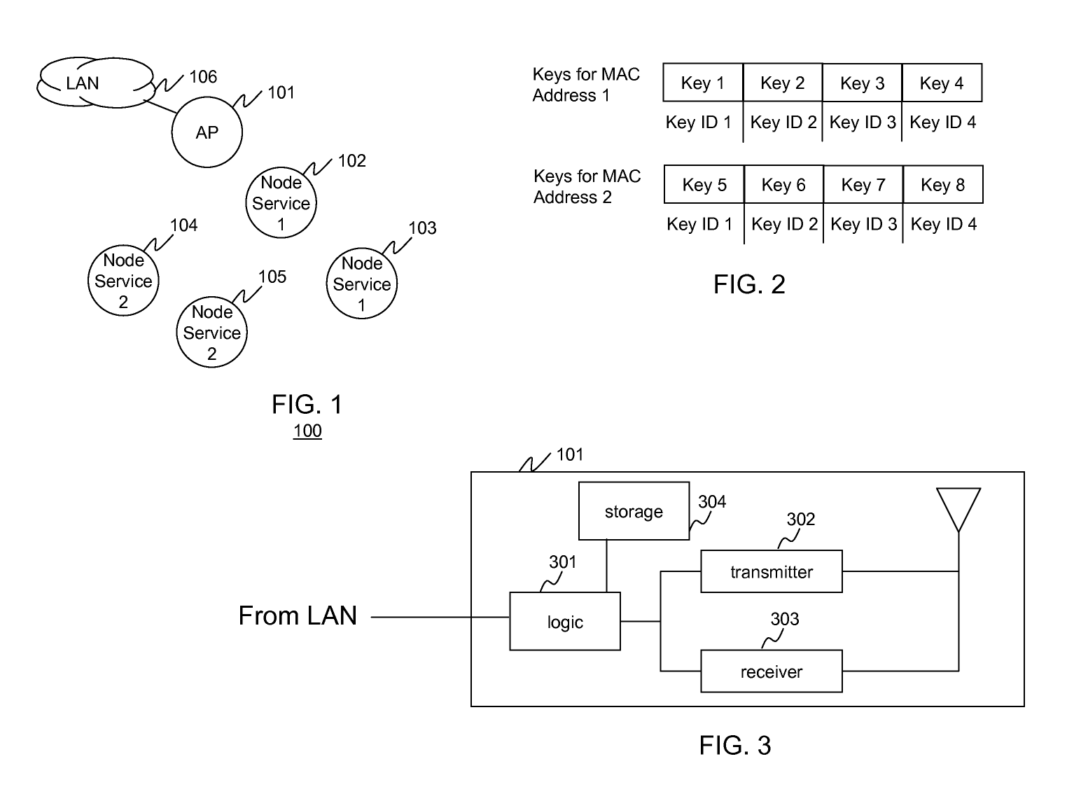

Turning now to the drawings, wherein like numerals designate like components, FIG. 1 is a block diagram of network 100. In the preferred embodiment of the present invention, network 100 utilizes a network protocol as described by the IEEE 802.11 specification. However, in alternate embodiments network 100 may utilize other network protocols such as, but not limited to, a network protocol defined by the IEEE 802.16 standard, a network protocol defined by the IEEE 802.15.3 Wireless Personal Area Networks for High Data Rates standard, or the network protocol defined by the IEEE 802.15.4 Low Rate Wireless Personal Area Networks standard, . . . , etc.

Network 100 includes a number of network elements such as access point 101 and nodes 102-105. Although only a single access point 101 and four nodes 102-105 are shown, one of ordinary skill in the art will recognize that typical networks comprise many access points in communication with many nodes. As shown, access point 101 is coupled to LAN 106. All nodes preferably access LAN 106 by communicating via transmissions over an RF communication channel through access point 101, but alternatively may comprise any transmission, either wired or wireless. It is contemplated that network elements within network 100 are configured in well known manners with processors, memories, instruction sets, and the like, which function in any suitable manner to perform the function set forth herein.

During operation nodes 102-103 utilize a first service, while nodes 104-105 utilize a second service. In one embodiment of the present invention the first service comprises a mesh service (using a mesh system protocol), while the second service comprises a non-mesh service (using a non-mesh system protocol). As discussed above, the group traffic for different services (mesh services versus AP services) should be encrypted using different group keys. That is, broadcast or multicast traffic sent to other mesh points 102-103 in network 100 should be encrypted using a group key that nodes 104-105 do not know. In a similar manner, nodes 102-103 should be unaware of the group key utilized by nodes 104-105.

In order to address this issue, access point 101 will utilize a plurality of MAC addresses, one for each service provided. According to the 802.11 specification, each MAC address has an associated lookup table containing encryption keys. The lookup table has 4 entries. One is reserved for pair-wise traffic. This is illustrated in FIG. 2.

As shown in FIG. 2, there exists a plurality of encryption keys 1-4 for each MAC address. Key storage locations for each MAC address defined in the original 802.11 standard (specifically, from wired equivalent privacy (WEP) security) limit the number of group keys a node may use for decoding traffic. In particular, each node can store a total of four encryption keys, which are identified using a two bit Key ID field transmitted in each frame. To maintain backwards compatibility, one storage location is reserved for the pairwise key. Key update mechanisms for group or shared keys require the use of two storage locations for a single key. Thus, only one group or shared key may be practically defined per MAC address. With this in mind, keys 1-4 are associated with MAC address 1, while keys 5-8 are associated with MAC address 2.

As discussed above, it is undesirable to have any device using the same multicast key for two services. Because of this, a differing transmitter MAC address is utilized for each service offered. From the perspective of the simple nodes associated with the MAP 101 (i.e., nodes 104-105), group traffic not sent using the MAP's mesh MAC address is ignored, and no decryption attempt is made. Likewise, mesh points (nodes 102-103) may ignore overheard group traffic sent using the MAC address for other services. This configuration allows independent, unique keys to be used for encrypting group traffic. Thus, for nodes utilizing the first service all group traffic sent will use the first MAC address. Likewise, all group traffic sent using the second service will use the second MAC address.

FIG. 3 is a block diagram of access point 101. As shown, access point 101 comprises logic circuitry 301, transmit circuitry 302, receive circuitry 303, and storage (database) 304. Storage 304 serves to store encryption keys, encryption key identities, and associated MAC addresses. Logic circuitry 301 preferably comprises a microprocessor controller, such as, but not limited to a Freescale PowerPC microprocessor. In the preferred embodiment of the present invention logic circuitry 301 serves as means for controlling access point 101, and as means for analyzing received message content, and means for encrypting transmissions. Transmit and receive circuitry 302-303 are common circuitry known in the art for communication utilizing a well known network protocols, and serve as means for transmitting and receiving messages. For example, for nodes 101-105, transmitter 302 and receiver 303 are well known IEEE 802.11 transmitters and receivers that utilize the IEEE 802.11 network protocol. Other possible transmitters and receivers include, but are not limited to transceivers utilizing Bluetooth, IEEE 802.16, or HyperLAN protocols. Finally, storage 304 comprises standard random access memory and is utilized for storing at least a first and a second MAC address and their associated encryption keys.

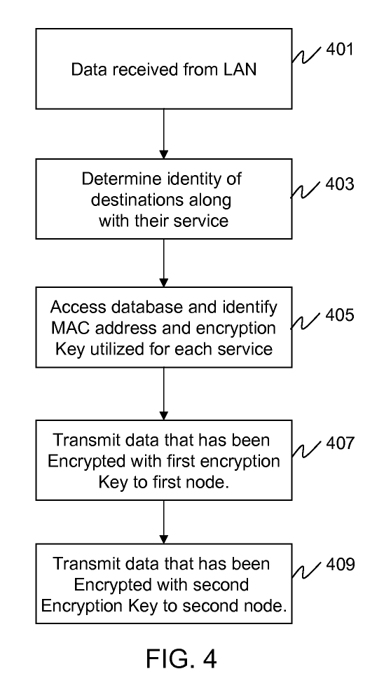

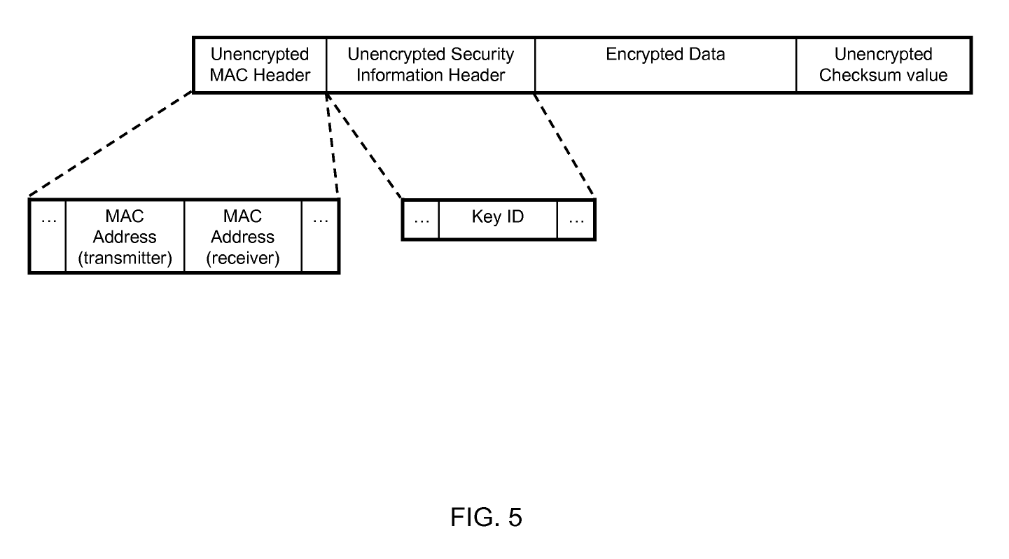

FIG. 4 is a flow chart showing operation of access point 101. During operation data transmitted to multiple users is transmitted utilizing a MAC address and encryption key associated with the user's particular service. The logic flow begins at step 401 where data is received from LAN 106 or from a node in network 100. At step 403 logic circuitry 301 determines an identity for the nodes that will receive the data along with the service utilized by the nodes. At step 405 logic circuitry 301 accesses database 304 and identifies a MAC address and encryption key utilized for each service used by the nodes. At step 407 data is addressed to a broadcast or multicast group address and is transmitted via transmitter 302 to a first group of nodes (which may be a single node), with the transmission being encrypted via a first encryption key. A first transmitter MAC address and a first encryption key identification is also transmitted to the first group of nodes. This is illustrated in FIG. 5. As shown in FIG. 5, the encrypted data is transmitted with an unencrypted header comprising the first transmitter MAC address and the first encryption key identification. At step 409 data is addressed to a broadcast or multicast group address and is transmitted via transmitter 302 to a second group of nodes (which may be a single node), the transmission is encrypted via a second encryption key. Additionally, a second transmitter MAC address and a second encryption key identification are transmitted to the second group of nodes. In particular, the encrypted data is transmitted with an unencrypted header comprising the second transmitter MAC address and the second encryption key identification.

During operation, access point 101 (receiver 303) may receive data from the first and the second nodes that has been encrypted with a third and fourth encryption key. If the first node is a member of a first group of nodes (102 and 103) that utilizes a mesh communications systems protocol, then the third encryption key may be a group encryption key if the received data has been addressed to a multicast or broadcast address or a pairwise encryption key if the received data has been addressed to the first transmitter MAC address. If the second node is a member of a second group of nodes (104 and 105) that utilizes the 802.11 communications systems protocol, then the received data will be addressed to the second transmitter MAC address and the fourth encryption key will be a pairwise encryption key. This data may be passed to LAN 106, or alternatively, forwarded to another node within network 100.

The above logic flow serves to transmit data to at least a first and a second node utilizing a first and a second service, respectively. Data encrypted with a first encryption key is transmitted to a first node from the first group of nodes. The first encryption key used for the transmission is identified by a first transmitter MAC address and a first encryption key identification. Similarly, data encrypted with a second encryption key is transmitted to a second node from the second group of nodes. The second encryption key used for the transmission is identified by a second transmitter MAC address and a second encryption key identification.

While the invention has been particularly shown and described with reference to a particular embodiment, it will be understood by those skilled in the art that various changes in form and details may be made therein without departing from the spirit and scope of the invention. It is intended that such changes come within the scope of the following claims.

1. A method for transmitting data to a first and a second group of nodes within a network, the method comprising the steps of:
transmitting data and a first MAC address to the first group of nodes, the data encrypted with a first encryption key; and
transmitting second data and a second MAC address to the second group of nodes, the second data encrypted with a second encryption key.

2. The method of claim 1 wherein the step of transmitting data comprises the step of transmitting a first encryption key identification, and wherein the step of transmitting the second data comprises the step of transmitting a second encryption key identification.

3. The method of claim 1 further comprising the steps of:
receiving data from a first node, wherein the first node is a member of the first group of nodes, encrypted with a third encryption key;
receiving data from the second node, wherein the second node is a member of the second group of nodes, encrypted with a fourth encryption key; and
forwarding the data received from the first and the second nodes.

4. The method of claim 3 wherein the step of forwarding the data comprises the step of forwarding the data to a local area network.

5. The method of claim 3 wherein the step of forwarding the data comprises the step of forwarding the data to a third node within the network.

6. The method of claim 1 wherein the step of transmitting data to the first group of nodes and transmitting second data to the second group of nodes comprises the step of wirelessly transmitting data and second data to the first and the second group of nodes.

7. The method of claim 1 wherein the first group of nodes comprises a group of nodes utilizing a mesh communication system protocol.

8. The method of claim 1 wherein the second group of nodes utilizes an 802.11 communication system protocol.

9. A method comprising the steps of:
receiving data from a local area network;
determining an identity for nodes that will receive the data;
determining a service used by the nodes that will receive the data;
determining a MAC address and encryption key for each service used by the nodes;
transmitting data, a first MAC address, and a first encryption key identification to a first node utilizing a first service, the data encrypted with a first encryption key that is identified by the first encryption key identification; and
transmitting second data, a second MAC address, and a second encryption key identification to a second node utilizing a second service, the second data encrypted with a second encryption key that is identified by the second encryption key identification.

10. The method of claim 9 further comprising the steps of:
receiving data from the first node encrypted with a third encryption key;
receiving data from the second node encrypted with a fourth encryption key; and
forwarding the data received from the first and the second nodes.

11. The method of claim 10 wherein the step of forwarding the data comprises the step of forwarding the data to a local area network.

12. The method of claim 10 wherein the step of forwarding the data comprises the step of forwarding the data to a third node.

13. The method of claim 9 wherein the step of transmitting data to the first node and transmitting second data to the second node comprises the step of wirelessly transmitting data and second data to the first and the second node.

14. The method of claim 9 wherein the first service comprises a mesh service.

15. The method of claim 9 wherein the second service comprises an 802.11 communication system protocol service.

16. An apparatus comprising:
a first MAC address;
a first encryption key associated with the first MAC address;
a second MAC address;
a second encryption key associated with the second MAC address; and
a transmitter transmitting data, the first MAC address, and a first encryption key identification to a first node utilizing a first service, the data encrypted with the first encryption key, the transmitter additionally transmitting second data, the second MAC address, and a second encryption key identification to a second node utilizing a second service, the second data encrypted with the second encryption key.

17. The apparatus of claim 16 further comprising:
a receiver receiving data from the first node encrypted with a third encryption key, and receiving data from the second node encrypted with a fourth encryption key.

18. The apparatus of claim 16 wherein the transmitter transmitted wirelessly to the first and the second nodes.

19. The apparatus of claim 16 wherein the first service comprises a mesh service.

20. The apparatus of claim 16 wherein the second service comprises an 802.11 communication system protocol service.
